(19) United States
(12) Patent Application Publication
(10) Pub. No.: US 2008/0031356 A1
(43) Pub. Date: Feb. 7, 2008

(54) INFORMATION PROCESSING APPARATUS AND DECODE CONTROLLING METHOD OF AN INFORMATION PROCESSING APPARATUS

(75) Inventors: Kosuke Uchida, Ome-shi (JP); Noriaki Kitada, Tokorozawa-shi (JP); Satoshi Hoshina, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/777,191

(22) Filed: Jul. 12, 2007

(30) Foreign Application Priority Data
Aug. 7, 2006 (JP) 2006-214817

(51) Int. Cl. H04N 11/02

(52) U.S. Cl. 375/240.25

(57) ABSTRACT

According to one embodiment, an information processing apparatus includes a determination unit configured to determine an encoded status of an encoded moving image data, an estimation unit configured to estimate a decoding load of the moving image data based on the encoded status of the moving image data determined by the determination unit, and a control unit configured to omit a part of a decoding process for decoding the moving image data based on the decoding load of the moving image data estimated by the estimation unit.

### CROSS-REFERENCE TO RELATED APPLICATIONS

This application is based upon and claims the benefit of priority from Japanese Patent Application No. 2006-214817, filed Aug. 7, 2006, the entire contents of which are incorporated herein by reference.

### BACKGROUND

1. Field

One embodiment of the invention relates to a decoding technique of a moving image suitable for applying to an information processing apparatus, such as a personal computer.

2. Description of the Related Art

In recent years, personal computers equipped with an AV function similar to that of an audio video (AV) equipment, such as a DVD (Digital Versatile Disc) player or a television apparatus, has become popular. This type of personal computer uses a software decoder which decodes moving image data by software. By using this software decoder, the encoded moving image data can be decoded by a processor (CPU) without having to set up a dedicated hardware separately.

In addition, recently, an H.264/AVC (Advanced Video Coding) standard is drawing attention as a moving image encoding technique for the next generation. Compared to the conventional encoding techniques such as MPEG2 and MPEG4, this H.264/AVC standard is an encoding technique with higher efficiency. Therefore, the encoding and decoding processes corresponding to the H.264/AVC standard each require more throughput than in the conventional encoding techniques, such as MPEG2 and MPEG4.

Accordingly, for a personal computer designed to decode a moving image data encoded by the H.264/AVC standard by software, when a system load increases, the decoding process itself becomes delayed, and a moving image may not be reproduced smoothly.

For example, in the moving image playback apparatus described in Jpn. Pat. Appln. KOKAI Publication No. 10-13794, a ring buffer is used on the output side of decoding to sense from the number of decoded pictures held in this ring buffer that decoding is unachievable in time. Further, in the case where decoding may not be achieved in time, it attempts to reduce the CPU load by dropping the frame.

Meanwhile, in the moving image playback apparatus described in Jpn. Pat. Appln. KOKAI Publication No. 10-13794, the number of decoded pictures held in the ring buffer becomes the criterion of whether or not to attempt reducing the CPU load. That is to say that reduction in the CPU load can only be attempted when decoding cannot be achieved in time.

Further, as it attempts to reduce the CPU load only by dropping the frame, there is a large difference between the cases of attempting and not attempting reduction in the CPU load.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 illustrates an example of a system configuration of an information processing apparatus concerned in an embodiment of the present invention.

FIG. 2 is an exemplary block diagram illustrating a functional configuration of a video playback application program which operates on the information processing apparatus of the embodiment.

FIG. 3 exemplifies a table provided for the video playback application program operated on the information processing apparatus of the embodiment to determine the level of decoding load from an encoded status of moving image data.

FIG. 4 exemplifies a table provided for the video playback application program operated on the information processing apparatus of the embodiment to determine the omission level of a decoding process from the level of decoding load.

FIG. 5 illustrates an exemplary sequence structure of the moving image data decoded by the video playback application program operated on the information processing apparatus of the embodiment.

FIG. 6 illustrates an exemplary field within the moving image data to which the video playback application program operated on the information processing apparatus of the embodiment refers for determining the presence/absence of deblocking.

FIG. 7 illustrates an exemplary field within the moving image data to which the video playback application program operated on the information processing apparatus of the embodiment refers for determining whether or not the moving image data is an interlace image.

FIG. 8 is an exemplary flowchart illustrating the procedure of the decoding process carried out by the video playback application program operated on the information processing apparatus of the above embodiment.

### DETAILED DESCRIPTION

Various embodiments according to the invention will be described hereinafter with reference to the accompanying drawings. In general, according to one embodiment of the invention, an information processing apparatus includes a determination unit configured to determine an encoded status of an encoded moving image data, an estimation unit configured to estimate a decoding load of the moving image data based on the encoded status of the moving image data determined by the determination unit, and a control unit configured to omit a part of a decoding process for decoding the moving image data based on the decoding load of the moving image data estimated by the estimation unit.

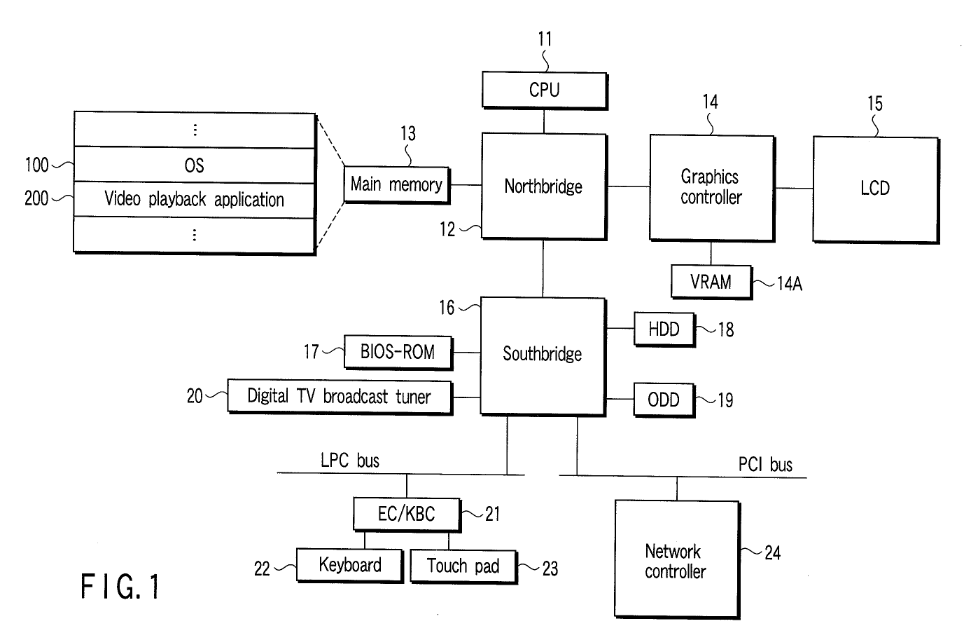

FIG. 1 illustrates an exemplary system configuration of an information processing apparatus concerned in an embodiment of the present invention. This information processing apparatus is realized in the form of, for example, a notebook type personal computer.

As illustrated in FIG. 1, this information processing apparatus comprises, for instance, a CPU 11, northbridge 12, main memory 13, graphics controller 14, video RAM (VRAM) 14A, LCD (Liquid Crystal Display) 15, southbridge 16, BIOS (Basic Input/Output System)—ROM 17, hard disk drive (HDD) 18, optical disk drive (ODD) 19, digital TV broadcast tuner 20, embedded controller/keyboard controller (EC/KBC) 21, keyboard 22, touch pad 23 and network controller 24.

The CPU 11 is a processor to control the operation of this information processing apparatus. It executes various programs, such as an operating system 100 and a video playback application program 200, downloaded from the HDD 18 to the main memory 13.

The video playback application program 200 is a software to decode and display an encoded moving image data. This video playback application program 200 is a software decoder corresponding to an H.264/AVC standard. The video playback application program 200 has a function to decode a moving image data (for example, a digital TV broadcast program received by the digital TV broadcast tuner 20 and a video content in HD (High Definition) standard retrieved from the ODD 19) encoded in an encoding scheme defined by the H.264/AVC standard.

Further, the CPU 11 also executes the BIOS stored in the BIOS-ROM 17. The BIOS is a program for hardware control.

The northbridge 12 is a bridge device to connect the local bus of the CPU 11 and the southbridge 16. The northbridge 12A has a built-in memory controller to carry out access control on the main memory 13.

The graphics controller 14 is a display controller which governs the display control of the LCD 15. The graphics controller 14 generates a display signal to be sent out to the LCD 15 from the image data written on the VRAM 14A.

The southbridge 16 controls each device on the LPC (Low Pin Count) bus and the PCI (Peripheral Component Interconnect) bus. In addition, the southbridge 16 is embedded with an IDE (Integrated Drive Electronics) controller for controlling the HDD 18. Further, the southbridge 16 functions to control the digital TV broadcast tuner 20 and to carry out access control on the BIOS-ROM 17.

The HDD 18 is a storage device which stores various software and data. The ODD 19 is a drive unit to drive a storage media, such as DVD which stores video contents. The digital TV broadcast tuner 20 is a receiving unit to receive external broadcast program data such as a digital TV broadcast program.

The EC/KBC 21 is a one-chip microcomputer on which an embedded controller for power control and a keyboard controller for controlling a keyboard 22 and a touch pad 23 are integrated. The network controller 24 is a communication device which establishes communication with an external network, such as the internet.

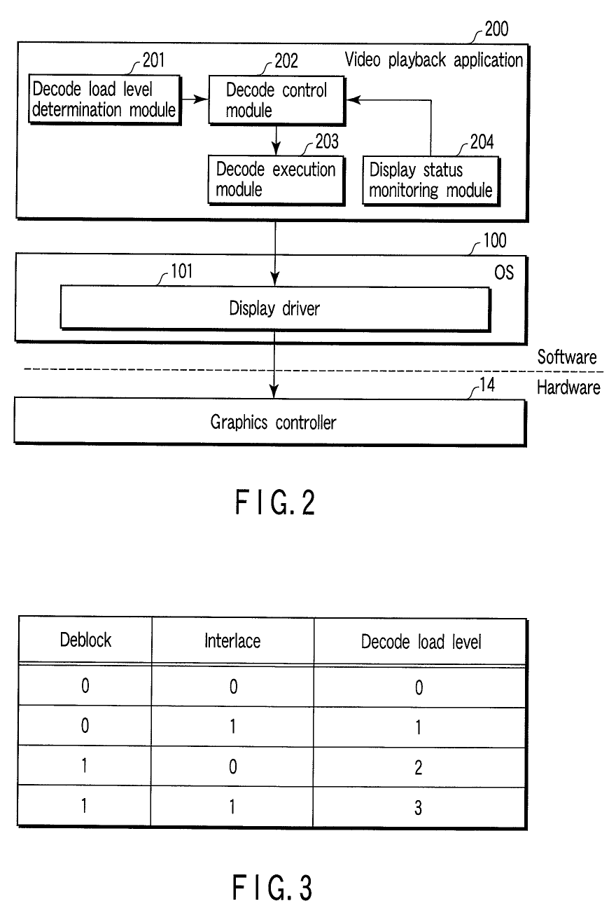

FIG. 2 is an exemplary block diagram illustrating a functional configuration of the video playback application program 200.

As shown in FIG. 2, the video playback application program 200 comprises a decode load level determination module 201, decode control module 202, decode execution module 203 and a display status monitoring module 204.

The decode execution module 203 executes a decoding process defined by the H.264/AVC standard. The decoding result obtained from this decode execution module 203 is written sequentially on the VRAM 14A of the graphics controller 14 via a display driver 101 of the operating system 100. In such manner, the decoded moving image data is displayed on the LCD 15. The display driver 101 is a software to control the graphics controller 14.

The decode load level determination module 201 checks an encoding status of the digital TV broadcast programs received by the digital TV broadcast tuner 20 and the HD standard video contents retrieved from the ODD 19, i.e. the moving image data encoded in an encoding scheme defined by the H.264/AVC standard, and estimates the decoding load of the moving image data from the encoded status.

Further, the display status monitoring module 204 monitors the display status of the moving image data decoded by the decode execution module 203. The decode control module 202 controls the decoding process carried out by the decode execution module 203, based on the estimation result of the decoding load obtained by the decode load level determination module 201 and the monitoring result of the display status obtained by the display status monitoring module 204.

More specifically, first, the decode load level determination module 201 checks whether or not each moving image data; (1), has a deblocking filter applied and (2), is an interlace image. Based on this result, the decode load level of the moving image data is determined as shown in FIG. 3.

That is, starting from the lowest decode load level 0, the decode load level is determined as (0,0) when a deblocking filter is not applied and it is not an interlace image, (0,1) when a deblocking filter is not applied and it is an interlace image, (1,0) when a deblocking filter is applied and it is not an interlace image, and (1,1) when a deblocking filter is applied and it is an interlace image. In this order, the decode load level increases in stages (1→2→3)

This type of table can be given to the video playback application program 200 as a parameter from an external source, or may be kept fixed in the video playback application program 200 as an internal data.

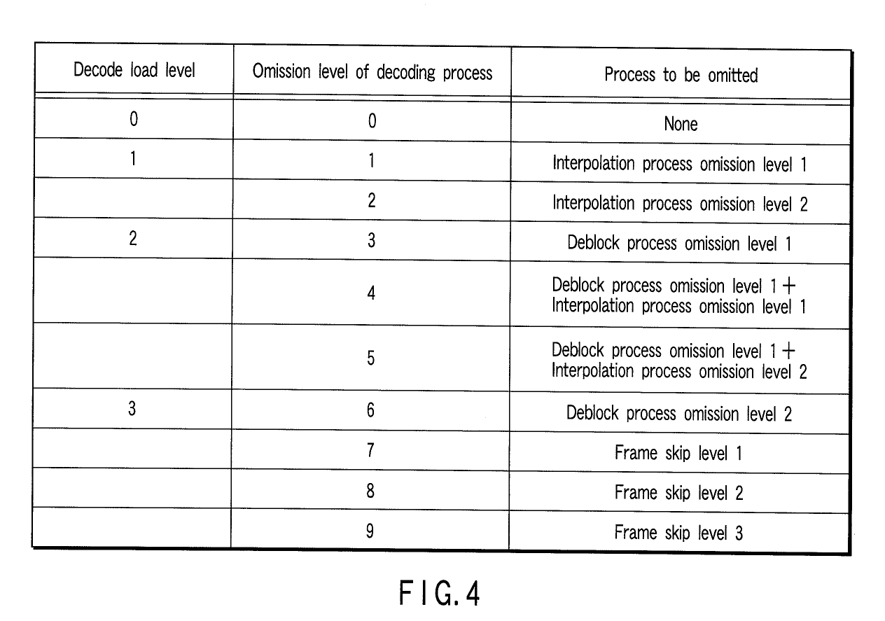

Subsequently, as shown in FIG. 4, the decode control module 202 determines the omission level of the decoding process based on the decode load level determined by the decode load level determination module 201. For example, if the decode load level determined by the decode load level determination module 201 is 1, the omission level is determined as 1, and if the decode load level is 2, the omission level is 3.

Based on the determined omission level, the decode control module 202 controls the decode execution module 203. For example, in the case where the omission level is determined as 1, an interpolating process will be omitted at a low level, and in the case of determining the omission level as 3, the deblocking process will be omitted at a low level.

When the decoding process is initiated by the decode execution module 203 under the control of this decode control module 202, the display status monitoring module 204 now monitors whether or not the output of the decoding result from the decode execution module 203 to the display driver 101 of the operating system 100 is performed without delay in comparison to the time stamp within the moving image data. The display status monitoring module 204 notifies this monitoring result to the decode control module 202.

Upon receiving a notification of delay, the decode control module 202 changes the omission level of the decoding process dynamically, such as, by changing the omission level to 2 when the current omission level is 1, and to 4, when the current level is 3.

Accordingly, the decode control module 202 has the interpolating process omitted at a high level in the case where the interpolating process has been omitted at a low level, and in the case where the deblocking process has been omitted at a low level, in addition to omitting this deblocking process at a low level, the interpolating process is further omitted at a low level.

Meanwhile, the display status monitoring module 204 also notifies the decode control module 202 in the case where there is allowance for the decoding result that can be output to the display driver 101 of the operating system 100 to be buffered at the decode execution module 203 side in more than a given quantity.

When receiving such notice, the decode control module 202 changes the omission level of the decoding process dynamically by, for instance, changing the omission level to 1 from the current omission level 2, and changing the omission level to 3 from the current omission level 4.

Accordingly, the decode control module 202 has the interpolating process omitted at a low level in the case where the interpolating process has been omitted at a high level, and in the case where the deblocking process has been omitted along with the interpolating process at a low level, only the omission of the interpolating process is terminated.

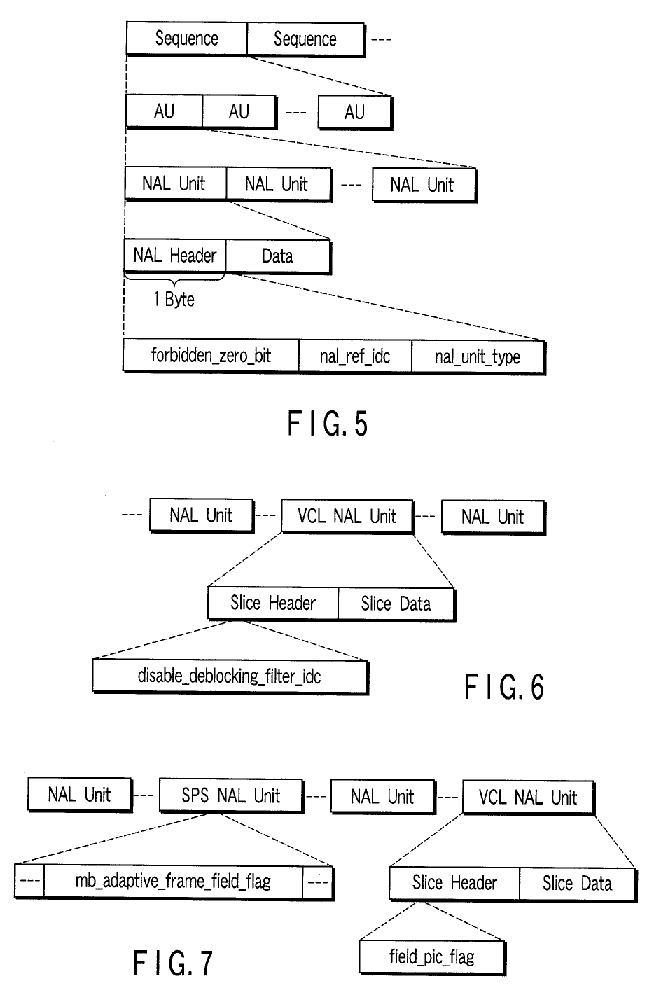

FIG. 5 illustrates an exemplary sequence structure of the moving image data decoded by the video playback application program 200. In this sequence structure, in the case where the value of “disable_deblocking_filter_idc” shown in FIG. 6 is other than “1”, it indicates that the deblocking filter is applied to the moving image data thereof.

The deblocking filter has a significantly high decoding load. Therefore, the decode load level determination module 201 primarily refers to the value of “disable_deblocking_filter_idc” to check whether or not the deblocking filter is applied.

Further, in the sequence structure of this moving image data, if the value of either one of “mb_adaptive_frame_field_flag” and “field_pic_flag” shown in FIG. 7 is “1”, it indicates that the moving image data is an interlace image.

Since the interlace image is in H.264/AVC standard, the decoding load is not as high. However, the interlace image causes the load for the entire system to increase upon display. Therefore, the decode load level determination module 201 secondly refers to this “mb adaptive_frame_field_flag” and “field_pic_flag” to check whether or not it is an interlace image.

In other words, by focusing attention on the load pattern, which is predictable to a certain extent from the encoded status of the moving image data, the video playback application program 200 determines the decode load level in advance and determines the omission level by increasing or decreasing the omission level in stages in accordance with the actual decoding status.

As shown in FIG. 4, the load of the decoding process is reduced in stages, in the order of the interpolating process, the deblocking and the frame skip. Here, the frame skip means to omit the decoding of a nonreference picture. Whether or not it is a nonreference picture can be checked by referring to “nal_unit_type” shown in FIG. 5. When this value is “0”, it is a nonreference picture. The reason why the nonreference picture is omitted is because if a reference picture is omitted, P/B picture decoding will become incapable. As long as there is no visible effect, the decoding of a plurality of nonreference pictures may be omitted.

Meanwhile, although the above description provides an example in view of only the encoded status of the moving image data, it is preferred that the decode load level and the omission level are determined by further checking and considering the throughput capacity of the CPU11. In other words, the omission level of the decoding process should be fixed in advance with respect to the throughput capacity of the CPU11 and the decode load level.

Further, since a large size moving image data, such as an HD size (1920×1088), increases the decode load level, it is also fine to determine the decode load level and the omission level by taking account of the size (such as, in the case of a small size moving image data, not performing decoding process omission).

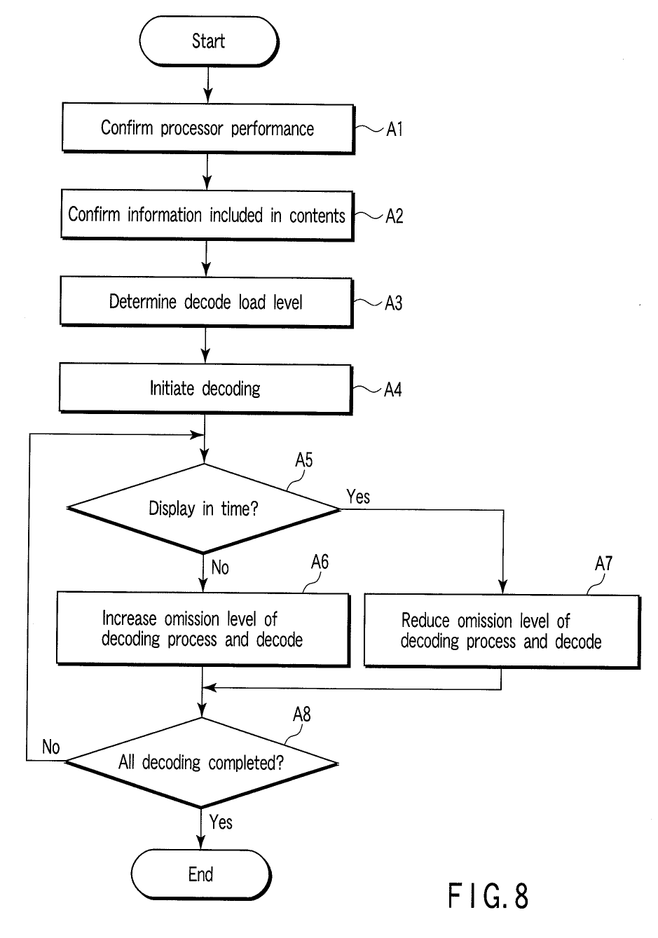

FIG. 8 is an exemplary flowchart illustrating the decoding process procedure executed by the video playback application program 200.

The decode load level determination module 201 confirms the throughput capacity of the CPU11 (block A1) along with the information (indicating the encoded status) included in the moving image data (block A2), and determines the decode load level from the confirmed CPU throughput capacity and the encoded status thereof (block A3).

Once the decode load level determination module 201 determines the decode load level, having determined the omission level, the decode control module 202 has the decode execution module 203 initiate the decoding process of the moving image data (step 4).

Further, once the decoding process is initiated, the display status monitoring module 204 monitors whether or not the display is in time (step 5). When this display status monitoring module 204 detects that the display is delayed (NO in block A5), the decode control module 202 controls the decode execution module 203 to increase the omission level (block A6). Meanwhile, if some allowance in buffering is detected (Yes in block A5), the decode control module 202 controls the decode execution module 203 to reduce omission levels (block A7).

The display status monitoring module 204 continues monitoring until the decode execution module 203 terminates the decoding process, and terminates this process when the decoding is terminated (Yes in block A8).

According to the information processing apparatus of the present embodiment, it is possible to arbitrarily reduce the CPU load by predicting the decoding load in advance from the encoded status of, for example, the moving image data in the above manner.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a determination unit configured to determine an encoded status of encoded moving image data;
an estimation unit configured to estimate a decoding load of the moving image data based on the encoded status of the moving image data determined by the determination unit; and
a control unit configured to omit a part of a decoding process for decoding the moving image data based on the decoding load of the moving image data estimated by the estimation unit.

2. The information processing apparatus according to claim 1, wherein;
the determination unit determines throughput capacity of a processor which executes the decoding process; and
the estimation unit estimates the decoding load of the moving image data based on the encoded status of the moving image data and the throughput capacity of the processor determined by the determination unit.

3. The information processing apparatus according to claim 1, further comprising a monitoring unit configured to monitor a display status of moving image data decoded by the decoding process,
wherein the control unit changes the content of the process to be omitted from the decoding process in stages so as to reduce the processing quantity of the decoding process in the case where the monitoring unit detects by monitoring that the display of the moving image data is delayed.

4. The information processing apparatus according to claim 3, wherein the control unit restores the omitted process within the decoding process in stages in the case where the monitoring unit detects by monitoring that the display of the moving image data is in time.

5. The information processing apparatus according to claim 1, wherein;
the determination unit determines whether or not a deblocking filter process is applied; and
the estimation unit estimates the decoding load to be higher than in the case where the deblocking filter process is not applied when the deblocking filter process is applied.

6. The information processing apparatus according to claim 1, wherein;
the determination unit determines whether or not the moving image data is an interlace image; and
the estimation unit estimates the decoding load to be higher than the case where the moving image is not an interlace image when the moving image is an interlace image.

7. The information processing apparatus according to claim 1, wherein;
the determination unit determines an image size; and
the estimation unit estimates the decoding load to be higher than in the case where the image size is smaller than a predetermined size when the image size is the predetermined size or larger.

8. The information processing apparatus according to claim 1, wherein the control unit omits an interpolating process within the decoding process.

9. The information processing apparatus according to claim 1, wherein the control omits a deblocking processing within the decoding process.

10. The information processing apparatus according claim 1, wherein the control unit omits the decoding process with respect to a nonreference picture within the moving image data.

11. A decode control method of an information processing apparatus executing a decoding process to decode an encoded moving image data, the method comprising:
determining an encoded status of the encoded moving image data;
estimating a decoding load of the moving image data based on the determined encoded status of the moving image data; and
omitting a partial process within the decoding process based on the estimated decoding load of the moving image data.

12. The decode control method of the information processing apparatus according to claim 11, further comprising determining throughput capacity of a processor to execute the decoding process.

13. The decode control method of the information processing apparatus according to claim 11, further comprising monitoring display status of moving image data decoded by the decoding process,
wherein the content of the partial process to be omitted from the decoding process is based on the display status of the moving image data.
